(19) United States
(12) Patent Application Publication
(10) Pub. No.: US 2018/0297852 A1
(43) Pub. Date: Oct. 18, 2018

(54) FLUIDIZED BED REACTOR AND PROCESS FOR PRODUCING POLYCRYSTALLINE SILICON GRANULES

(71) Applicant: Wacker Chemie AG, Munich (DE)

(72) Inventors: Simon PEDRON, Burghausen (DE); Bernhard BAUMANN, Emmerting (DE)

(73) Assignee: Wacker Chemie AG, Munich (DE)

(21) Appl. No.: 15/737,967

(22) PCT Filed: Nov. 9, 2016
(86) PCT No.: PCT/EP2016/077031

§ 371 Date: Dec. 19, 2017

(30) Foreign Application Priority Data
Dec. 2, 2015 (DE) 10 2015 224 120.3

(51) Int. Cl. C01B 33/027; B01J 8/18; B01J 8/24

(52) U.S. Cl. CPC C01B 33/027; B01J 8/1836; B01J 2219/0227; B01J 8/1827; B01J 2208/00902; B01J 8/24

(57) ABSTRACT

Campaigns for the production of polycrystalline silicon granules in a fluidized bed process are lengthened by employing an inner reaction tube within the fluidized bed reactor which has a low ash content, preferably a coefficient of thermal expansion similar to that of silicon carbide, and has a silicon carbide coating layer consisting of at least 99.995 wt. % of silicon carbide with a thickness of from 5 μm to 700 μm.

### CROSS REFERENCE TO RELATED APPLICATIONS

This application is the U.S. National Phase of PCT Appln. No. PCT/EP2016/077031 filed Nov. 9, 2016, which claims priority to German Application No. 10 2015 224 120.3 filed Dec. 2, 2015, the disclosures of which are incorporated in their entirety by reference herein.

### BACKGROUND OF THE INVENTION

### 1. Field of the Invention

The invention relates to a fluidized-bed reactor and to a process for producing granular polycrystalline silicon.

### 2. Description of the Related Art

Granular polycrystalline silicon is produced in a fluidized-bed reactor. This occurs by fluidization of silicon particles by means of a gas flow in a fluidized bed, with this being heated to high temperatures by means of a heating device. As a result of addition of a silicon-containing reaction gas, a deposition reaction occurs on the particles surfaceselemental silicon is deposited on the silicon particles, and the individual particles grow in diameter. The process can be operated continuously with all the advantages associated therewith by regular offtake of grown particles and addition of relatively small silicon seed particles. Silicon-halogen compounds (e.g. chlorosilanes or bromosilanes), monosilane (SiH₄) and mixtures of these gases with hydrogen have been described as silicon-containing feed gases.

Such deposition processes and apparatuses for this purpose are known. The corresponding prior art and the many demands made of a material for the reactor tube of the fluidized-bed reactor for producing granular polycrystalline silicon are set forth in DE 102014212049. This patent application discloses a fluidized-bed reactor having a reactor tube whose main element comprises at least 60% by weight of silicon carbide, with the main element having, at least on its inside, a CVD coating having a layer thickness of at least 5 μm and comprising at least 99.995% by weight of silicon carbide. Silicon carbide has a brittle fracture behavior typical of ceramic materials. Furthermore, high thermally induced stresses can build up during operation of the reactor because of the high E modulus, generally E>200 GPa. In order to keep these stresses low, the reactor construction and the process conditions have to be such that temperature gradients in the axial, radial and tangential directions are very low.

### SUMMARY OF THE INVENTION

It is an object of the present invention to achieve a further improvement in a fluidized-bed reactor for producing granular polycrystalline silicon and in the process for producing granular polycrystalline silicon. This and other objects are achieved by a fluidized-bed reactor comprising a reactor vessel (1), a reactor tube (2) and a reactor bottom (15) within the reactor vessel (1), where the reactor tube (2) consists of a main element and a surface coating and an intermediate jacket (3) is present between an outer wall of the reactor tube (2) and an inner wall of the reactor vessel (1), further comprising a heating device (5), at least one bottom gas nozzle (9) for introduction of fluidizing gas and also at least one secondary gas nozzle (10) for introduction of reaction gas, a feed device (11) for introducing silicon nucleus particles, an offtake conduit (14) for granular polycrystalline silicon and a facility for discharging reactor offgas (16), characterized in that the main element of the reactor tube consists of a base material having an ash content of <2000 ppmw and the surface coating is a CVD coating which has a layer thickness of from 5 μm to 700 μm and comprises at least 99.995% by weight of silicon carbide.

### BRIEF DESCRIPTION OF THE PREFERRED EMBODIMENTS

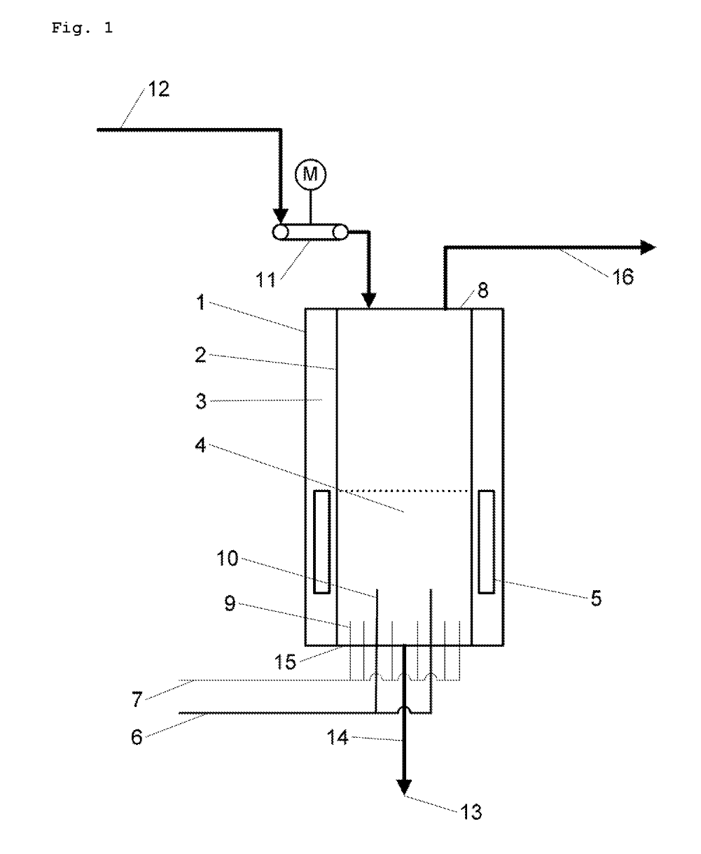

FIG. 1 shows the schematic structure of one embodiment of a fluidized-bed reactor of the invention.

### DETAILED DESCRIPTION OF THE PREFERRED EMBODIMENTS

The main element of the reactor tube preferably consists of a base material having an ash content of <50 ppmw, more preferably a base material having an ash content of <1 ppmw. The base material preferably has a coefficient of thermal expansion (average value in the range from 20 to 1000° C.) of from 3.5·10⁻⁶ to 6.0·10⁻⁶ K⁻¹, preferably from 4·10⁻⁶ to 5.5·10⁻⁶ K⁻¹. The coefficient of thermal expansion of the base material most preferably corresponds to the coefficient of thermal expansion of silicon carbide (4.6·10⁻⁶ to 5.0·10⁻⁶ K⁻¹). Main element and coating thus preferably have substantially the same coefficient of thermal expansion.

Suitable base materials are isostatically pressed graphite and materials whose main component is carbon and which have the abovementioned properties. These are, for example, an adapted carbon fiber-reinforced carbon (CFC material), a carbon-carbon (C/C) composite material or a rolled-up graphite foil. The base material is preferably isostatically pressed graphite, which will also be referred to as isographite for short.

The surface coating comprising SiC is present on the tube inside or on the tube inside and the tube outside of the reactor tube. The end faces of the reactor tube can likewise have a surface coating.

The penetration depth of the CVD coating into the base material is preferably less than 2.5 times the maximum peak-to-valley height Rₘₐₓ.

The CVD coating comprising SiC preferably has a layer thickness of from 15 to 500 μm, more preferably a layer thickness of from 50 to 200 μm.

The materials of the reactor tube allow use up to a temperature of at least 1600° C., which represents an advantage over, for example, the silicon nitride proposed in the prior art, which is stable only up to 1250° C.

The graphite tube can be produced in one piece but also with a plurality of parts, e.g. made of two or more tube sections. In this way, manufacture can firstly be made easier, and secondly individual sections are able to be replaced in the case of a defect. Coating of the graphite tube or the parts of the graphite tube with silicon carbide is carried out in a known way in a CVD reactor.

In the fluidized-bed reactor of the invention, the intermediate jacket preferably comprises an insulation material and is filled with an inert gas or is flushed with an inert gas. Nitrogen is preferably used as an inert gas.

The pressure in the intermediate jacket is preferably higher than in the reaction space.

The high purity of the SiC coating of at least 99.995% by weight of SiC ensures that dopants (electron donors and acceptors, for example B, Al, As, P), metals, carbon, oxygen or chemical compounds of these substances are present only in low concentrations in the regions close to the surface of the reactor tube, so that the individual elements cannot enter in an appreciable amount into the fluidized bed, either by diffusion or by abrasion.

No free silicon and no free carbon are present at the surface. Inertness in respect of H₂, chlorosilanes, HCl and N₂ is ensured thereby.

Contamination of the granular polycrystalline silicon with carbon is prevented by the high-purity CVD coating since appreciable amounts of carbon would be transferred from pure SiC only in contact with liquid silicon.

The invention also provides a process for producing granular polycrystalline silicon in the fluidized-bed reactor of the invention having the new type of reactor tube, comprising the fluidization of silicon nucleus particles by means of a gas flow in a fluidized bed which is heated by means of a heating device, where polycrystalline silicon is deposited on the hot silicon seed particle surfaces by addition of a silicon-containing reaction gas, as a result of which the granular polycrystalline silicon is formed.

The granular polycrystalline silicon formed is preferably discharged from the fluidized bed reactor. Silicon deposits on walls of reactor tube and other reactor components are preferably subsequently removed by introduction of a corroding gas into the reaction zone. The corroding gas preferably contains hydrogen chloride or silicon tetrachloride.

Preference is likewise given to corroding gas being introduced continuously during deposition of polycrystalline silicon on the hot silicon nucleus particle surfaces in order to avoid silicon deposits on walls of reactor tube and other reactor components. The introduction of the corroding gas is preferably effected locally into a free board zone, which is the gas space above the fluidized bed. The wall coating can thus be corroded away cyclically in alternation with the deposition process. As an alternative, corroding gas can be continuously introduced locally during a deposition operation in order to avoid formation of a wall coating.

The process is preferably operated continuously by particles which have grown in diameter as a result of deposition being discharged from the reactor and fresh silicon seed particles being introduced.

Preference is given to using trichlorosilane as a silicon-containing reaction gas. The temperature of the fluidized bed in the reaction region is, in this case, more than 900° C. and preferably more than 1000° C. The temperature of the fluidized bed is preferably at least 1100° C., more preferably at least 1150° C. and most preferably at least 1200° C. The temperature of the fluidized bed in the reaction region can also be 1300-1400° C. The temperature of the fluidized bed in the reaction region is most preferably from 1150° C. to 1250° C. A maximum deposition rate is achieved in this temperature range, and drops again at even higher temperatures. Preference is likewise given to using monosilane as a silicon-containing reaction gas. The temperature of the fluidized bed in the reaction region, in this case, is preferably 550-850° C. Preference is also given to using dichlorosilane as silicon-containing reaction gas where the temperature of the fluidized bed in the reaction region is preferably 600-1000° C. The fluidizing gas is preferably hydrogen.

The reaction gas is injected into the fluidized bed via one or more nozzles. The local gas velocities at the outlet of the nozzles are preferably from 0.5 to 200 m/s. The concentration of the silicon-containing reaction gas is, based on the total amount of gas flowing through the fluidized bed, preferably from 5 mol % to 50 mol %, more preferably from 15 mol % to 40 mol %.

The concentration of the silicon-containing reaction gas in the reaction gas nozzles is, based on the total amount of gas flowing through the reaction gas nozzles, preferably from 20 mol % to 80 mol %, more preferably from 30 mol % to 60 mol %. As the silicon-containing reaction gas, preference is given to using trichlorosilane.

The absolute reactor pressure is generally in the range from 1 to 10 bar, preferably in the range from 1.5 to 5.5 bar.

In the case of a reactor having a diameter of, for example, 400 mm, the mass flow of silicon-containing reaction gas is preferably from 30 to 600 kg/h. The hydrogen volume flow is preferably from 100 to 300 standard m³/h. For larger reactors, greater amounts of silicon-containing reaction gas and H₂ are preferred.

It will be clear to one skilled in the art that some process parameters are ideally selected as a function of the reactor size. For this reason, operating data normalized to the reactor cross-sectional area, at which the process of the invention is preferably operated, are indicated below.

The specific mass flow of silicon-containing reaction gas is preferably 400-6500 kg/(h*m²). The specific hydrogen volume flow is preferably 800-4000 standard m³/(h*m²). The specific bed weight is preferably 700-2000 kg/m². The specific silicon seed particle introduction rate is preferably 7-25 kg/(h*m²). The specific reactor heating power is preferably 800-3000 kW/m². The residence time of the reaction gas in the fluidized bed is preferably from 0.1 to 10 s, more preferably from 0.2 to 5 s. The features indicated with respect to the abovementioned embodiments of the process of the invention can correspondingly be applied to the apparatus of the invention. Conversely, the features indicated with respect to the abovementioned embodiments of the apparatus of the invention can correspondingly be applied to the process of the invention. These and other features of the embodiments of the invention are explained in the description of the figures and in the claims. The individual features can be realized either separately or in combination as embodiments of the invention. Furthermore, they can describe advantageous embodiments which are independently protectable.

### LIST OF REFERENCE NUMERALS

1 reactor vessel

2 reactor tube

3 intermediate jacket

4 fluidized bed

5 heating device

6 reaction gas

7 fluidizing gas

8 top of the reactor

9 bottom gas nozzle

10 secondary gas nozzle

11 seed introduction device

12 seed

13 granular polycrystalline silicon

14 offtake conduit

15 reactor bottom

16 reactor offgas

The fluidized-bed reactor consists of a reactor vessel 1 into which a reactor tube 2 has been inserted.

Between the inner wall of the reactor vessel 1 and the outer wall of the reactor tube 2, there is an intermediate jacket 3. The intermediate jacket 3 contains insulation material and is filled with an inert gas or is flushed with an inert gas.

The pressure in the intermediate jacket 3 is higher than in the reaction space, which is delimited by the walls of the reactor tube 2.

In the interior of the reactor tube 2, there is the fluidized bed 4 made up of granular polysilicon. The gas space above the fluidized bed (above the broken line) is usually referred to as “free board zone”.

The fluidized bed 4 is heated by means of a heating device 5.

As feed gases, the fluidizing gas 7 and the reaction gas mixture 6 are fed into the reactor The introduction of gas is effected in a targeted manner via nozzles.

The fluidizing gas 7 is introduced via bottom gas nozzles 9 and the reaction gas mixture is introduced via secondary gas nozzles (reaction gas nozzles) 10.

The height of the secondary gas nozzles 10 can differ from the height of the bottom gas nozzles 9.

A bubble-forming fluidized bed 4 is formed in the reactor by the arrangement of the nozzles with additional vertical secondary gas injection.

The top 8 of the reactor can have a greater cross section than the fluidized bed 4.

Seed 12 is introduced into the reactor at the top 8 of the reactor via a seed introduction device 11 having an electric drive M.

The granular polycrystalline silicon 13 is taken off via an offtake conduit 14 at the bottom 15 of the reactor.

At the top 8 of the reactor, the reactor offgas 16 is taken off.

### Deposition

In a fluidized-bed reactor, high-purity granular polysilicon is deposited from trichlorosilane. Hydrogen is used as fluidizing gas. The deposition takes place at a pressure of 300 kPa (abs) in a reactor tube having an internal diameter of 500 mm. Product is taken off continuously and the introduction of seed is regulated in such a way that the Sauter diameter of the product is 1000±50 μm. The intermediate jacket is flushed with nitrogen. A total of 800 kg/h of gas is introduced, with 17.5 mol % of this consisting of trichlorosilane and the remainder consisting of hydrogen.

### Example 1

If the reactor tube consists of isographite having an average coefficient of thermal expansion of 5.0*10⁻⁶ K⁻¹ with CVD coating having an average layer thickness of 200 μm, a fluidized bed temperature of 1200° C. can be attained.

The reaction gas reacts to equilibrium. 38.9 kg of silicon per hour can be deposited in this way.

An area-based yield of 198 kg h⁻m⁻² of silicon is obtained.

### Comparative Example 1

If, in contrast, the reactor tube consists of fused silica, a fluidized bed temperature of only 980° C. can be attained since otherwise a temperature of 1150° C. is exceeded in the long term on the heated reactor tube outside.

29.8 kg of silicon per hour can be deposited (90% of the equilibrium yield).

An area-based yield of 152 kg h⁻¹m⁻² of silicon is obtained in this way.

The differences in the average values of the dopant, carbon and metal contents in the product between the two processes are smaller than the statistical scatter.

### Comparative Example 2

However, if the reactor tube consists of isographite without surface treatment, the hydrogen attacks the free carbon of the tube. This leads to impairment of the mechanical stability of the reactor tube through to failure of the component. The consequence is exchange of material between the intermediate jacket and the reaction space.

During the process, hydrogen can react with a carbon-containing heater and with the nitrogen used as inert gas to form the toxic product HCN.

In the deposition process, the product comes into contact with contaminants from the heating space and the carbon of the reactor tube. Nitrogen is also incorporated into the product. Silanes react on the hot heater surface to form silicon nitride which forms white surface growths there. Contact with hot, conductive granular silicon can in the extreme case also lead to grounding of the heater. The reactor has to be taken out of operation. The reactor tube is no longer usable for further runs.

### Comparative Example 3

A tube made of vibrated graphite and having an average coefficient of thermal expansion of 2.8 pm/K has cracks straight after coating. Although a process at a temperature of 1200° C. can be started up, the base material is slowly attacked by the hydrogen. The compounds methane and carburized silanes which form lead to contamination of the product with carbon and the introduction of carburized silanes and methane into the offgas stream, which leads to problems in the subsequent distillation.

### Comparative Example 4

If the tube consists of SiSiC with SiC coating, the radial temperature gradient in the heating zone is limited to 13 K/mm. If a reactor tube according to the invention is used, the radial temperature gradient is limited to 21 K/mm. In practice, this means that the heating zone has to be made longer in a process using an SiC tube than in a process using a coated graphite tube. This restricts the freedom in the process, in particular in the selection of the height of the fluidized bed.

The above description of illustrative embodiments should be interpreted as being merely by way of example. The disclosure arising therefrom makes it possible firstly for a person skilled in the art to understand the present invention and the associated advantages and secondly encompasses adaptations and modifications which are obvious to a person skilled in the art of the structures and processes described. All such adaptations and modifications and also equivalents are therefore intended to be covered by the scope of protection of the claims.

1.-11. (canceled)

12. A fluidized-bed reactor for producing granular polycrystalline silicon, comprising: a reactor vessel, and a reactor tube and a reactor bottom within the reactor vessel, wherein the reactor tube comprises a main element with a surface coating, and an intermediate jacket is present between an outer wall of the reactor tube and an inner wall of the reactor vessel, and further comprising a heating device, at least one fluidizing gas nozzle for introduction of a fluidizing gas and at least one reaction gas nozzle for introduction of reaction gas, a silicon seed particle feed for introducing silicon seed particles, an offtake conduit for granular polycrystalline silicon product and a reactor offgas discharge, wherein the main element of the reactor tube comprises a base material having an ash content of <2000 ppmw and the surface coating is a CVD coating which has a layer thickness of from 5 μm to 700 μm and comprises at least 99.995 % by weight of silicon carbide.

13. The fluidized-bed reactor of claim 12, wherein the main element of the reactor tube comprises a base material having an ash content of <50 ppmw.

14. The fluidized-bed reactor of claim 12, wherein the main element of the reactor tube comprises a base material having an ash content of <1 ppmw.

15. The fluidized-bed reactor of claim 12, wherein the base material has an average coefficient of thermal expansion in the range from 20 to 1000° C. of from 3.5·10⁻⁶ to 6.0·10⁻⁶K⁻¹.

16. The fluidized-bed reactor of claim 15, wherein the coefficient of thermal expansion of the base material corresponds to the coefficient of thermal expansion of silicon carbide, 4.6·10⁻⁶ to 5.0·10⁻⁶K⁻¹.

17. The fluidized-bed reactor of claim 15, wherein the base material comprises isostatically pressed graphite, carbon fiber-reinforced carbon, a carbon-carbon (C/C) composite material, a rolled-up graphite foil, or a combination thereof.

18. The fluidized-bed reactor of claim 17, wherein the base material comprises isostatically pressed graphite.

19. The fluidized-bed reactor of claim 12, wherein the CVD coating has a layer thickness of 15-500 μm.

20. The fluidized-bed reactor of claim 12, wherein the intermediate jacket comprises an insulation material and is filled with or flushed with an inert gas.

21. A process for producing granular polycrystalline silicon, comprising fluidizing silicon seed particles by means of a gas flow in a fluidized bed which is heated by means of a heating device, where polycrystalline silicon is deposited on hot silicon seed particle surfaces in a reaction zone by addition of a silicon-containing reaction gas to form granular polycrystalline silicon, wherein the process is carried out in a fluidized-bed reactor of claim 12.

22. The process of claim 21, wherein the granular polycrystalline silicon is discharged from the fluidized-bed reactor, and wherein silicon deposited on walls of the reactor tube and other reactor components removed by introducing a corroding gas into the reaction zone.

23. The process of claim 22, wherein the corroding gas contains hydrogen chloride, silicon tetrachloride or a mixture thereof.
